(19) United States
(12) Patent Application Publication
(10) Pub. No.: US 2014/0334959 A1
(43) Pub. Date: Nov. 13, 2014

(54) SUPERCHARGER TORSIONAL COMPLIANCE AND DAMPING FEATURES

(71) Applicant: Eaton Corporation, Cleveland, OH (US)

(72) Inventors: Brian W. Franke, Hamilton, IN (US); Michael J. Hornbrook, Orland, IN (US); David Gerard Rauen, Battle Creek, MI (US); Rodney Champlin Glover, St. Clair Shores, MI (US); Thomas Jonathan Walsh, Marshall, MI (US); Bryn Tailer Dixon, Marshall, MI (US); Randal J. Graves, Marshall, MI (US)

(21) Appl. No.: 14/147,188

(22) Filed: Jan. 3, 2014

Related U.S. Application Data
(63) Continuation-in-part of application No. 29/459,965, filed on Jul. 5, 2013.
(60) Provisional application No. 61/821,219, filed on May 8, 2013.
(60) Provisional application No. 61/843,096, filed on Jul. 5, 2013.
(60) Provisional application No. 61/884,720, filed on Sep. 30, 2013.

(51) Int. Cl. F04C 29/00; F04C 18/12; F16D 11/16; F02B 33/38

(52) U.S. Cl. CPC F04C 29/005; F02B 33/38; F04C 18/12; F16D 11/16
USPC 418/69; 418/206.7; 192/71

(57) ABSTRACT

A positive displacement pump (8) comprises a cylindrical input shaft (13) comprising a first area (A1) with a first diameter (D1), a second area (A2) with a second diameter (D2), and a third area (A3) with a third diameter (D3), where the second diameter is greater than the first diameter and the third diameter. A stator (19) is press fit to a portion of the third area. A cylindrical bushing (15) is press fit around the second area. When the input shaft (13) rotates, the torsional vibration damping bushing (15) resists the rotation. The pump also comprises a clutch assembly (21). A clutch armature (29) of the assembly comprises a cylindrical, hollow passageway (290) and radially extending arms (39). Each arm comprises an opening (293), at least one slot (295) passing through the arm, and at least one void (297) abutting the slot, the void passing through the arm. When the clutch assembly engages, the armature damps vibrations.

### FIELD

This application relates to positive displacement pumps such as Roots-type rotary blowers and screw-type air pumps. More specifically, the application provides damping structures and torsional compliance features for torque transmitting parts of a supercharger.

### BACKGROUND

Positive displacement pumps, such as Roots or screw-type superchargers can suffer from vibrations as torque is transmitted from a crankshaft of a motor or engine to the shafts that turn the lobes of the supercharger. The vibrations can occur along the shafts and, when a clutch or transmission is used to transfer torque, “chatter” can occur between facing surfaces in the clutch or transmission.

In addition, when the pump is used to supply air to an engine of a motive device, the user may notice “lurching” as the pump turns abruptly on and off.

### SUMMARY

The methods disclosed herein overcome the above disadvantages and improves the art by way of a positive displacement pump which may comprise a cylindrical input shaft comprising a first area with a first diameter, a second area with a second diameter, and a third area with a third diameter, where the second diameter is greater than the first diameter and the third diameter. A first bearing may surround a portion of the first area. A second bearing may surround a portion of the third area. A stator assembly may be press fit to another portion of the third area. A cylindrical bushing may be press fit around the second area. When the input shaft rotates, the bushing resists the rotation, thereby creating heat.

An armature assembly may comprise a plurality of coupling means, a friction disc with a plurality of spaced holes, a plurality of springs, each spring comprising a first end and a second end, and an armature.

The armature may comprise a cylindrical, hollow passageway, radially extending arms, each arm comprising, an opening, at least one slot passing through the arm, and at least one void abutting the slot, the void passing through the arm.

The plurality of springs may be distributed on the disc such that every other spaced hole of the friction disc is coupled via respective coupling means to a respective first end of a respective spring. The remaining spaced holes of the friction disc may coupled via respective coupling means to respective second ends of the plurality of springs. Respective second ends of the plurality of springs may be coupled to respective openings of the armature

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1A is a cross-section view of a supercharger.

FIG. 1B is a view of the input shaft for the supercharger of FIG. 1A, with shaft diameters indicated.

FIG. 1C is an alternative input shaft and damper arrangement.

FIG. 1D is a view of the input shaft of FIG. 1C with shaft diameters indicated.

FIG. 2 is a view of a clutch assembly.

FIG. 3 is a view of an armature assembly of the clutch assembly.

FIG. 4 is a view of an armature of the armature assembly.

FIG. 5A is another view of the armature of FIG. 4.

FIG. 5B is a view of an alternative armature.

FIG. 6A is a view of a damper.

FIG. 6B is a view of the damper along A-A with inner and outer diameters of the damper indicated.

FIG. 7A is a cross-section view of another embodiment of a damper.

FIG. 7B is an alternative view of FIG. 7B.

FIG. 8A is a cross-section view of another embodiment of a damper.

FIG. 8B is a cross-section view of yet another embodiment of a damper.

FIG. 9 is a view of an end cap.

FIG. 10A is a simplified view of an input hub, input shaft, and clutch assembly.

FIG. 10B is a graph of input shaft twist as a function of input shaft length.

FIG. 10C is an alternative view of the input shaft of FIG. 10A along a central axis, indicating twisting resonance.

FIG. 11A is a simplified view of an input hub, input shaft, and clutch assembly having another alternative damper.

FIG. 11B is another view of the input shaft and alternative damper of FIG. 11A along a central axis.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

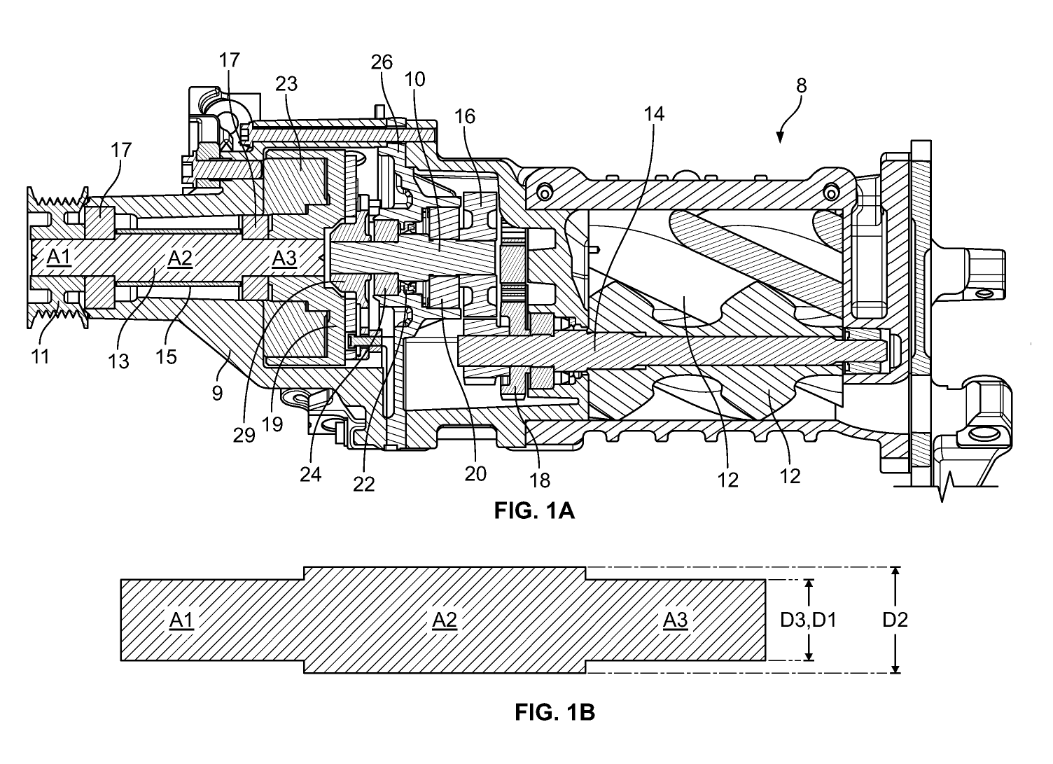

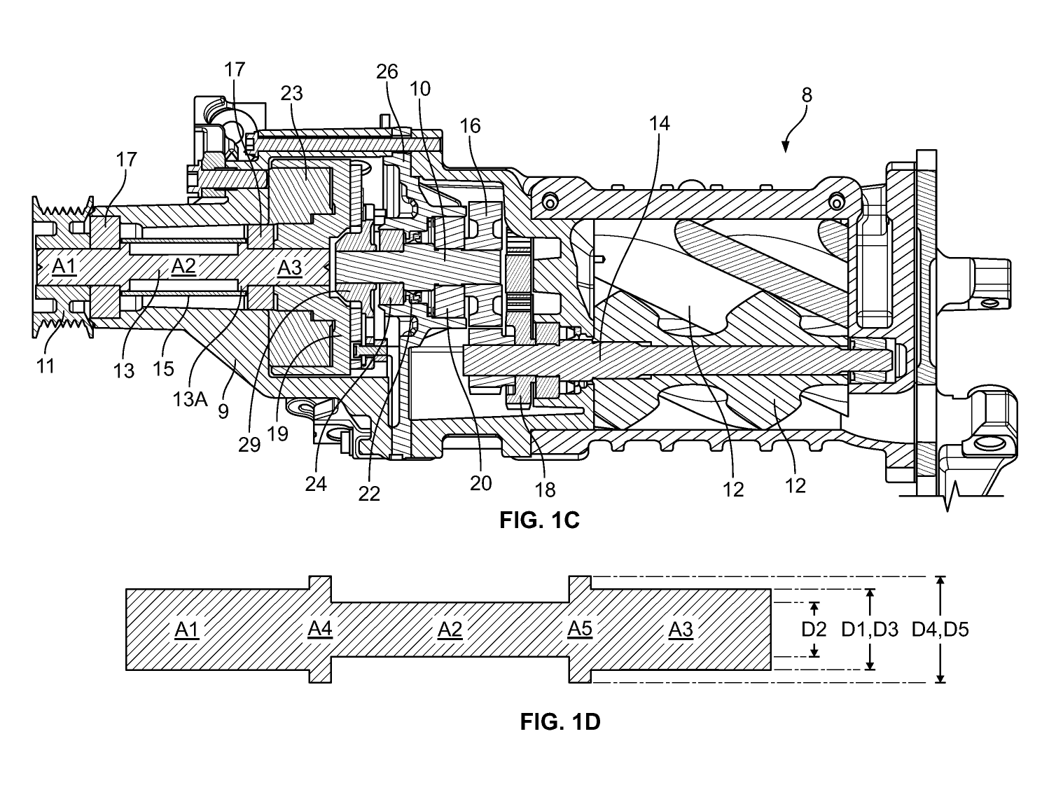

FIG. 1A shows a cross-section view of a positive displacement type supercharger 8. Supercharger 8 may be a screw type or parallel lobe Roots design. The supercharger may include many of the features shown in U.S. Pat. No. 8,464,697, incorporated herein by reference in its entirety. The supercharger may include two lobes, as illustrated, or may include three or four lobes.

An input pulley hub 11 connects to a drive mechanism such as a pulley belt to receive rotational energy from a driver, such as a crankshaft of an engine of a vehicle. The drive mechanism connects to a cylindrical input shaft 13. The input shaft is fitted with bearings 17 to align the input shaft 13 in the housing 9 and to allow the input shaft 13 to rotate in the housing 9. The input shaft 13 has a first area A1 with a first diameter D1, a second area A2 with an increased diameter D2, and a third area A3 of reduced diameter D3. In the illustrated example of FIG. 1A, D2 is greater than D1 which is greater than D3 (D2>D1>D3). Depending on design D3>D1, or, as illustrated in FIG. 1B, D1=D3.

In FIGS. 1A and 1B, second area A2 has an increased diameter D2 to provide a damping mass to the input shaft 13. Varying the diameter of second area A2 varies a resonant frequency in Hertz (Hz) at which the input shaft may vibrate. A torsional damper 15 is press fitted to the input shaft at second area A2. The press-fit damper 15, which may be a chamfered bushing, provides a torsionally stiff structure in which the input shaft 13 twists against the friction of the press-fit. It is possible that D1=D2=D3, and the damper 15 provides the requisite damping mass to the input shaft 13.

As shown in FIG. 1C, it is possible to reduce the second diameter D2 to less than D1 and D3 if the system design can accommodate the change in frequency. Such a decrease in second diameter D2 could include the use of raised lips 13A in areas A4 and A5. The areas A4 and A5 would have matching diameters D4 and D5 so that the damper 15 may be press-fit to the raised lips 13A instead of directly to the full length of section A2 of the shaft. As above, D1=D3, or D1<D3, or D3<D1. FIG. 1D illustrates D1=D3 and D4=D5.

Returning to FIGS. 1A and 1B, by using an inner damper diameter DD that is slightly larger than the second diameter A2, high friction between the damper 15 and second area A2 can be achieved. Thus, if the clutch experiences chatter as torque transfers from input shaft 13 to intermediate shaft 18 by coupling stator 19 and disc 28, torsional resonance can be damped by damper 15. For FIG. 1A, the torsional energy may be dissipated as heat in the interface between the damper 15 and second area A2 as the input shaft 13 tries to twist against the relatively stiff damper 15.

For FIG. 1C, the torsional energy may be dissipated as heat in the interface between the damper 15 and fourth and fifth areas A4 and A5 as the input shaft 13 tries to twist against the relatively stiff damper 15.

Reducing the interference between the inner surface of the damper, such as by increasing inner damper diameter DD or decreasing the diameter of the touching areas of the input shaft, will allow the input shaft 13 to twist more inside the damper 15; and, as the thinner inner shaft 13 twists more, the amplitude of vibration increases and the damper 15 provides more damping. FIGS. 6A and 6B show the inner damper diameter DD and the outer damper diameter OD, along with an optional chamfer 15D.

Additional damper modifications can include a lengthwise slit 15B in the press fit damper 15A. FIGS. 11A and 11B show an input shaft 13 of uniform diameter coupled to clutch assembly 21 and input hub 11. Input shaft 13 may comprise the above diameter variations, but is shown for simplicity without them. The diameter of the damper 15A is chosen to press against input shaft 13. The outer diameter of the cylindrical bushing is chosen relative to the diameter of the input shaft so that the cylindrical bushing provides a radial clamping force around the second area. The width of the slit 15B is chosen to control the amount of radial clamping force. The slit 15B relieves the need for tightly controlled press-fit diameter tolerances. As the damper 15A and input shaft 13 wear down along their friction surfaces, the clamping force is maintained by reduction in the slit width as the clamping force closes the slit 15B.

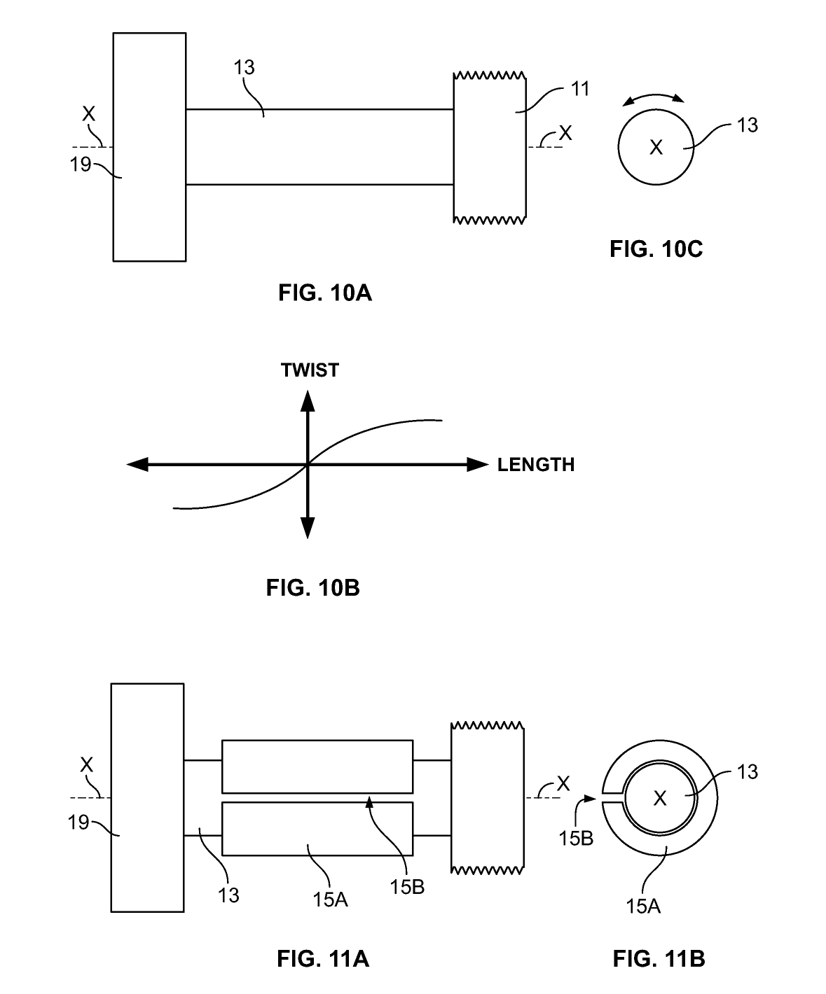

FIGS. 10A-10C illustrate the torsional vibration damper concepts. FIG. 10A is a simplified view of an input hub 11, input shaft 13, and stator 19. A central longitudinal axis X-X is the axis around which the input shaft 13 rotates. FIG. 10B is a graph of input shaft twist as a function of input shaft length. FIG. 10C is an alternative view of the input shaft of FIG. 10A along a central axis, illustrating twisting resonance. The double-headed arrow of FIG. 10C indicates that the resonance is in either rotational direction of the input shaft. With the damper around the input shaft 13, and a torque load applied to the input hub 11, the damper 15 or 15A can rotate around the input shaft 13 in either direction in response to the resonance.

While not shown in FIG. 1A, 1B, or 11A, a visco-elastic material, such as a damping material by Trelleborg AB, may be used to interface between the input shaft 13 and damper 15 or 15A. Or, the damper may comprise a visco-elastic material, or visco-elastic and metal material combination.

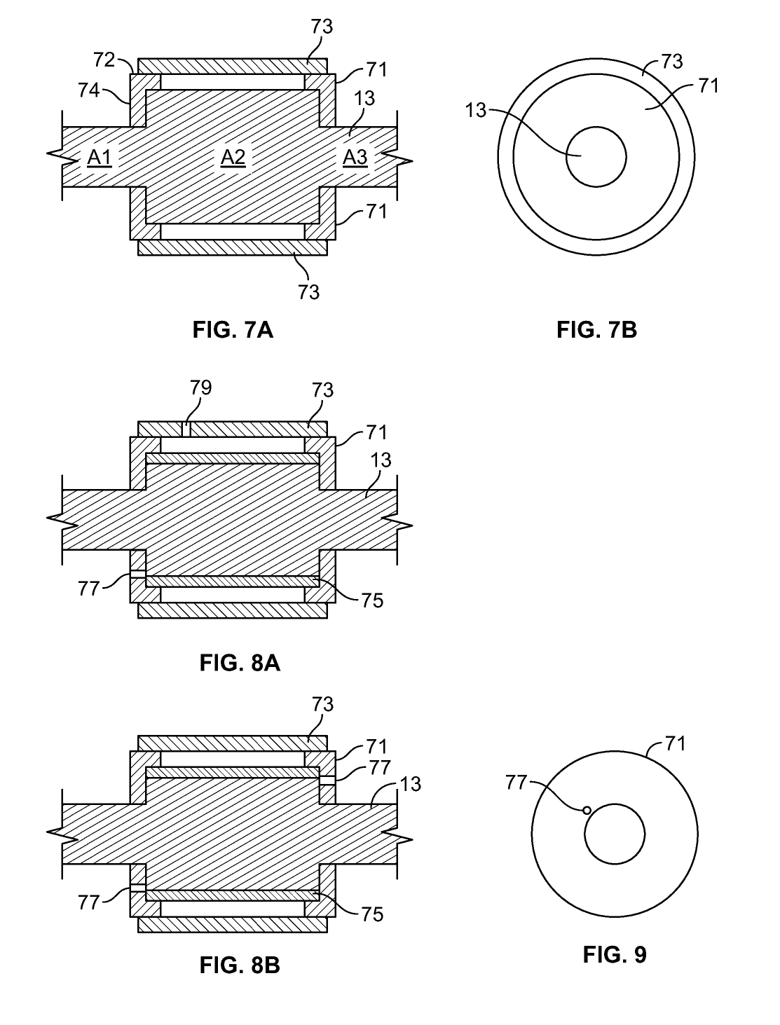

Other alternatives to the sleeve-like friction damper 15 are shown in FIGS. 7A-9, 11A, and 11B. In FIG. 7A, ends of the input shaft 14 are surrounded by caps 71. The caps 71 have an “L” shaped cross section. An upper portion 72 abuts the outermost diameter of second area A2 and is toleranced to provide a friction fit so that torsional energy is dissipated as heat. A side portion 74 may abut first area A1 on its outermost diameter, and may abut a side of area A2. A sleeve 73 may be brazed to the caps 71 for further damping effects. The use of the cap 71 and sleeve 73 design alleviates tolerancing requirements, as the sleeve 73 may be poorly toleranced while the inner diameter of upper portion 72 must have strict machining tolerance. FIG. 7B shows a side view of 7A along a central axis of the input shaft 13.

FIG. 8 illustrates yet another alternative. An elastomeric sheet 75 abuts the second area A2. The caps 71, which may be loosely toleranced, hold the sheet 75 in place. The outer sleeve 73 may then be brazed to the caps 71. The sheet 75 may be a cut and fitted sheet of TRELLEBORG AB's damping elastomer, or it may be a sleeve of the material. The sheet or sleeve may be epoxied in place and the cap and sleeve may be epoxied or brazed in place.

Alternatively, a liquid may be injected in to a cavity formed by cap 71 and sleeve 73. FIGS. 8A and 8B illustrate that injection molding holes 77 may be formed in one or both of the caps, or an injection molding hole 79 may be formed in a selected place in the sleeve to allow for injection of a liquid. The liquid may set (harden) to provide damping capabilities. A first hole of the injection molding holes 77 and 79 may allow for an injection port, and a second hole of the injection molding holes 77 and 79 may provide a suction port or expulsion port.

To couple torque from the input shaft 13 to the transmission assembly of the supercharger, a stator 19 is press fit to the input shaft 13. An electrically controllable electromagnetic coil assembly 23 is seated in the stator 19. When a signal actuates the coil assembly 23, it attracts an armature assembly 21 such that a surface of the stator 19 may grip a disc 28 of the armature assembly 21. The face of the stator 19 may include a friction grip material 31, which may be disc-shaped. Or, the stator 19 may comprise a powder-metal composite that is configured to grip disc 28. The armature assembly 21 may comprise a magnetic material that is attracted when the coil assembly 23 is powered, but that is not attracted when the coil assembly 23 is not powered. The magnetic material may be included in the armature 29, the disc 28, or in both the armature 29 and the disc 28. The disc 28 additionally comprises a friction grip surface to couple to the stator 19.

The stator 19 and disc 28 act as a clutch to selectively couple torque from the input shaft 13 to intermediate shaft 10. When the torque is transferring, it is possible that the interface experiences stick-slip, which excites torsional vibration which is composed of torsional stiffness of input shaft 13 and torsional inertia of stator 19. As one example, first mode vibration of 500 Hz may occur as the disc 28 and stator 19 resist one another. As above, the torsional vibration may be damped by damper 15. When torque transfer is complete, the coil assembly 23 may be deactivated and the disc 28 may uncouple from the stator 19.

Affiliated bearings 24 and 20 brace the intermediate shaft 10 against a housing section 26 and enables the intermediate shaft 10 to rotate when torque is transferred to intermediate shaft 10. A transmission 16 may include step up and other timing gears to transfer torque to gears 18 holding lobes 12. The illustrated example shows a first lobe shaft 14 rotationally coupled to the transmission 16 and to a first of the gears 18. The first gear 18 is coupled to turn the second gear 18. The lobe shaft 14 is supported for rotation against an end of the outer housing along with an end of the other lobe 12. Thus, the lobes 12 of the supercharger may turn as torque is transferred from the drive mechanism, across the clutch assembly and through the transmission 16 on the intermediate shaft 10.

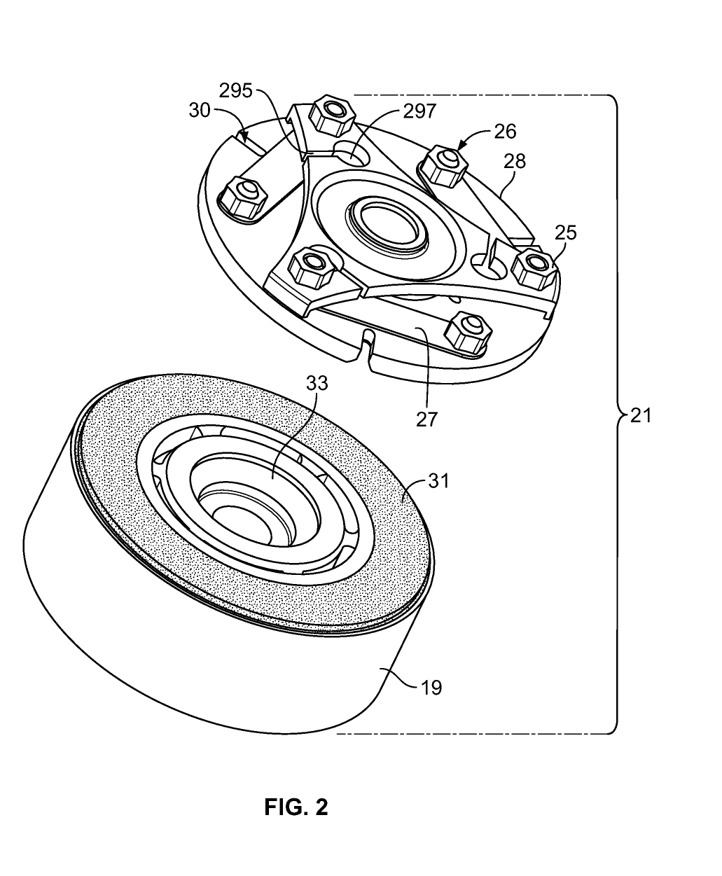

The clutch assembly 21 is illustrated in more detail in FIGS. 2 and 3. Disc 28 may include notches 30 for a purpose such as wiping debris along the grip-coupling surface. The disc 28 may include threading or screw seats in holes 233 and 231. An armature hub, also referred to herein as an armature, 29 couples to the disc 28 via nuts 25 coupled to screws in holes 231. First ends of springs 27 couple between the armature 29 and the disc 28 at holes 231, and second ends of springs 27 couple via screws in holes 233 and nuts 26.

Turning to FIG. 4, the armature 29 has a central, cylindrical, hollow passageway 290. The passageway 290 is surrounded by, in this example, three radially extending arms 39. The shape formed by this combination is generally pyramidal. That is, the triangle-like arms 39 are arranged to form a shape similar to a pyramid, though the armature 29 may include curves, bent portions such as fingers 291, chamfering or other shape modifications that cause the overall shape of the armature 29 to deviate from the geometrical definition of a regular pyramid.

Fingers 291 at the ends of the arms 39 may seat against the disc 28. The armature may comprise threaded or unthreaded openings 293 for receiving screws. A first side of the armature 29 may include a central lip 298 around the passageway 290. A recess 299 may surround the central lip 298. The armature 29 may then transition from the recess 299 to the arms 39, which may have a thickness greater than or equal to the height of the lip 298.

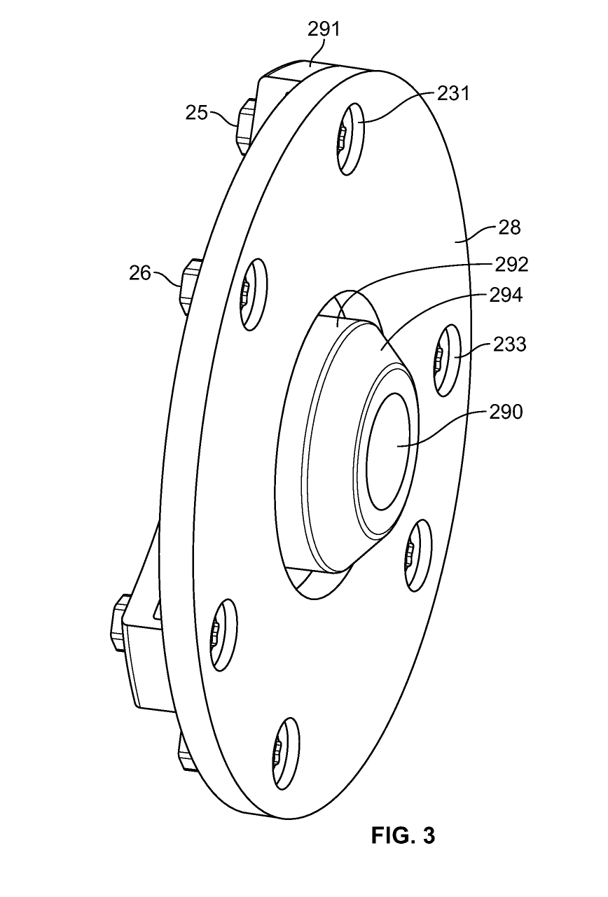

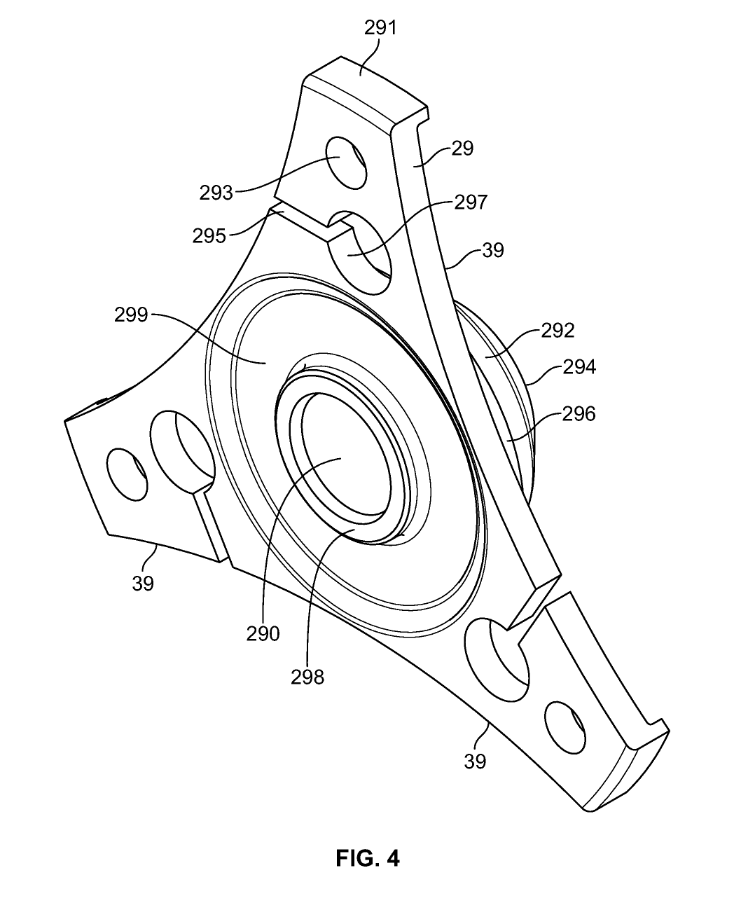

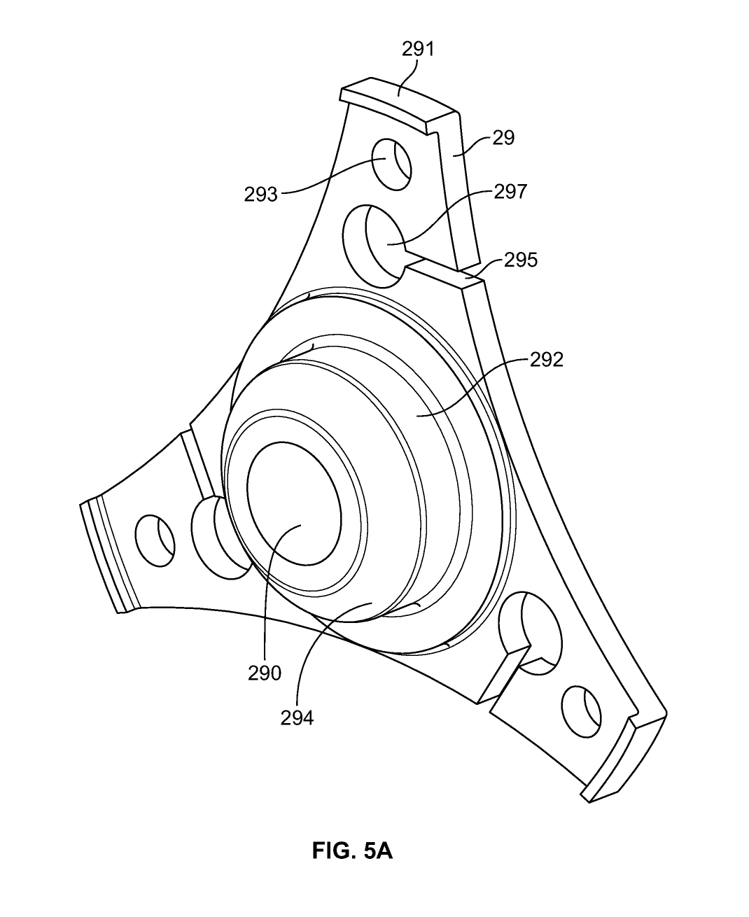

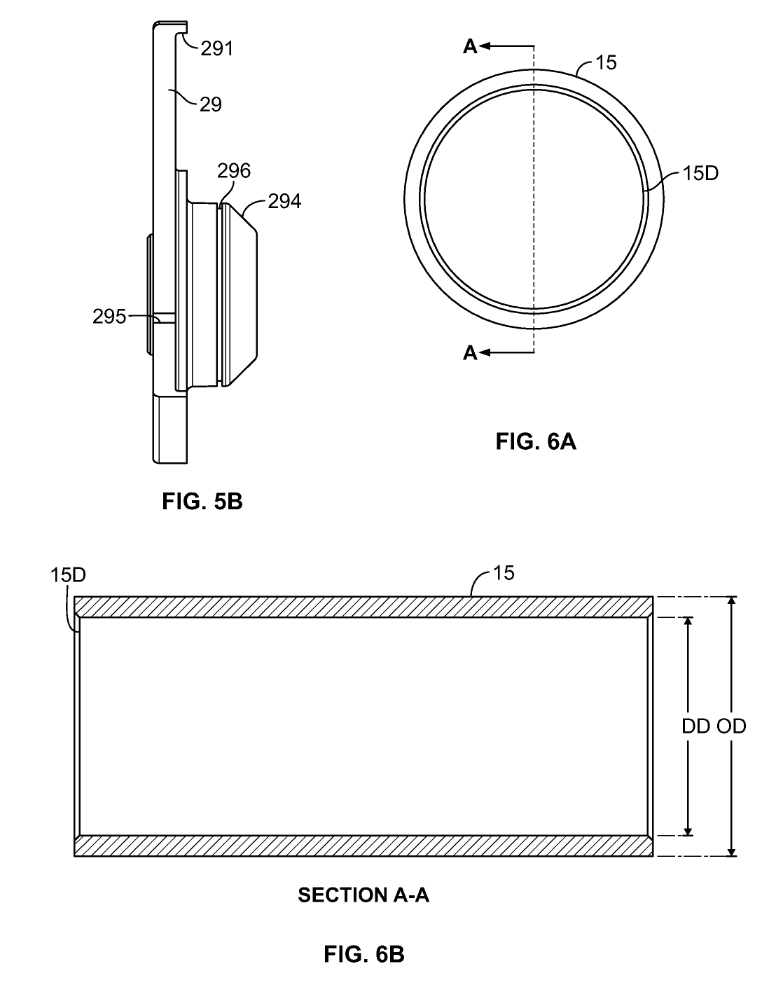

A second side of the armature may include a neck 292 that extends the passageway 290. Passageway 290 press fits to intermediate shaft 10. The neck 292 is generally cylindrical and may include diameter changes, such as recess 296 in FIG. 5B and taper 294 in FIG. 5A. The diameter changes of the neck 292 can abut corresponding recesses in stator 19. For example, taper 294 may abut recess 33 when the coil assembly 23 pulls the armature assembly 21 towards stator 19. Other modifications and uses can include using the diameter change recess 296 as an assembly or disassembly recess, whereby a tool can grip the neck 292 for installation or de-installation.

The springs 27 provide a torque or speed-sensitive mechanism. The springs can flex should the disc 28 receive a sufficient amount of torque from stator 19. The springs 27 allow relative motion between disc 28 and armature 29.

A generally rectangular slot 295 may pass through each arm of armature 29. A generally circular void 297 may abut each slot 295. The voids 297 and slots 295 cooperate to reduce the mass of the armature 29, and the mass change adjusts the Hertz at which the armature vibrates. The slots 295 and voids 297 also provide a selective weakness in the armature 29 that enables twisting of the armature 29. The increased flexing of the armature and increased ability to vibrate at specific frequencies allows armature 29 to damp other vibrations in the supercharger 8, such as vibrations caused by the coupling “chatter” between the stator 19 and the disc 28. Thus, in addition to the relative motion between disc 28 and armature 29 afforded by use of springs 27, armature 29 can twist relative to disc 28 to concentrate strain at armature 29. This alleviates strain in other parts of the supercharger 8 as the lobes 12 resist torque applied by the drive mechanism. Since the twist in armature 29, and the bend of springs 27 can be loaded and unloaded gradually relative to other instantaneous on/off couplings, “lurching” can be reduced or avoided. That is, lobes 12 can be spun up more gradually and can be unpowered more gradually so that an affiliated compressed air receiving system, such as an engine of a motive device, experiences less abrupt changes in air supply.

The vibration range of the armature may be chosen to cancel out other vibrations and thus reduce the operating noise of the supercharger. Thus, the size and placement of the slots and voids can be changed for intended operating conditions. For example, the slot width does not have to be uniform and can be varied along the length of the slot to achieve a desired effect.

The added compliance of the armature also enables the selection of resonance ranges that occur before stick-slip occurs between the stator 19 and disc 28. And, if the vibration cannot be cancelled out completely, the timing of the chatter can be controlled and the frequency of the damping can be adjusted to less detectable ranges. Thus, with appropriate selection of the size of slots 295 and voids 297, the operating noise of the supercharger can be adjusted along audible and non-audible ranges of frequencies.

Ordinarily, the stator 19 assembly and armature assembly 21 shake, or chatter, as torque transfers from the input shaft 13 to the intermediate shaft 10. The armature 29 illustrated drops the natural frequency of the rotor vibration by almost 4. The slots 295 and voids 297 in the armature 29 can also result in a reduction in the number of cycles available to build resonant amplitudes.

By combining the press fit damper 15 and the armature 29, significant noise and chatter reduction occurs. An end user driver experiences less perceptible changes as the supercharger engages, both via the reduced noise, and also because of the smoother transition from powered to unpowered supercharger states.

Other implementations will be apparent to those skilled in the art from consideration of the specification and practice of the examples disclosed herein. For example, it may be advantageous to vary number of arms 39 on armature 29, such that more than three arms are spaced about the cylindrical, hollow passageway 290. Such an increase would require an increased number of springs 27 and holes 231 and 233. It is intended that the specification and examples be considered as exemplary only, with a true scope and spirit of the invention being indicated by the following claims.

What is claimed is:

1. A positive displacement pump, comprising:
a cylindrical input shaft comprising a first area with a first diameter, a second area with a second diameter, and a third area with a third diameter, where the second diameter is greater than the first diameter and the second diameter is greater than the third diameter;
a first bearing surrounding a portion of the first area;
a second bearing surrounding a portion of the third area;
a stator press fit to another portion of the third area; and
a cylindrical bushing press fit around the second area,
wherein, when the input shaft rotates, the cylindrical bushing resists the rotation, thereby creating heat.

2. The pump of claim 1, further comprising:
a cylindrical intermediate shaft comprising a first end and a second end;
an armature press fit to the first end of the intermediate shaft;
a friction disc attached to the armature; and
a transmission attached to the second end of the intermediate shaft.

3. The pump of claim 2, further comprising an electrically controllable electromagnetic coil assembly affiliated with the stator, wherein the stator comprises a coupling surface, wherein one or both of the friction disc or the armature comprises a magnetic material, and wherein, when the coil assembly is powered, the magnetic material is attracted to the coil assembly and the coupling surface of the stator contacts the friction disc.

4. The pump of claim 2, further comprising springs between the friction disc and the armature.

5. The pump of claim 2, wherein the armature comprises:
a cylindrical, hollow passageway for press-fitting to the intermediate shaft;
radially extending arms surrounding the passageway to form a generally pyramidal shape, each arm comprising:
means to couple to the disc; and
at least one slot passing through the arm; and
at least one void abutting the slot, the void passing through the arm.

6. The pump of claim 5, wherein the slot is generally rectangular, and wherein the void is generally circular.

7. The pump of claim 5, wherein the at least one slot comprises a width and a length, and wherein the slot width varies along the slot length.

8. The pump of claim 1, wherein the cylindrical bushing is hollow and comprises a length and an outer diameter, and wherein the cylindrical bushing comprises a slit along the length of the outer diameter.

9. The pump of claim 8, wherein the outer diameter of the cylindrical bushing is chosen relative to the diameter of the second area of the input shaft so that the cylindrical bushing provides a radial clamping force around the second area.

10. A clutch armature comprising:
a cylindrical, hollow passageway;
radially extending arms surrounding the passageway to form a generally pyramidal shape, each arm comprising:
an opening;
at least one slot passing through the arm; and
at least one void abutting the slot, the void passing through the arm.

11. The armature of claim 10, wherein each arm further comprises a distal finger.

12. The armature of claim 10, wherein the slot is generally rectangular, and wherein the void is generally circular

13. The armature of claim 10, wherein the at least one slot comprises a width and a length, and wherein the slot width varies along the slot length.

14. An armature assembly, comprising:
a plurality of coupling means;
a friction disc with a plurality of spaced holes;
a plurality of springs, each spring comprising a first end and a second end; and
an armature comprising:
a cylindrical, hollow passageway;
radially extending arms, each arm comprising:
an opening;
at least one slot passing through the arm; and
at least one void abutting the slot, the void passing through the arm,
wherein the plurality of springs are distributed on the disc such that every other spaced hole of the friction disc is coupled via respective coupling means to a respective first end of a respective spring,
wherein the remaining spaced holes of the friction disc are coupled via respective coupling means to respective second ends of the plurality of springs, and
wherein respective second ends of the plurality of springs are coupled to respective openings of the armature.

15. The assembly of claim 14, wherein the disc further comprises a plurality of notches.

16. An armature assembly, comprising:
a plurality of coupling means;
a friction disc with six spaced holes;
three springs, each spring comprising a first end and a second end; and
an armature comprising:
a cylindrical, hollow passageway;
three radially extending arms, each arm comprising:
an opening;
at least one slot passing through the arm; and
at least one void abutting the slot, the void passing through the arm,
wherein the three springs are distributed on the disc such that the first hole is coupled to the first end of the first spring, the second hole is coupled to the second end of the first spring, the third hole is coupled to the first end of the second spring, the fourth hole is coupled to the second end of the second spring, the fifth hole is coupled to the first end of the third spring, and the sixth hole is coupled to the second end of the third spring,
wherein the second end of the first spring is coupled to the opening of the first arm, the second end of the second spring is coupled to the opening of the second arm, and the second end of the third spring is coupled to the opening of the third arm.

17. A positive displacement pump (8), comprising:
an input hub (11);
a stator (19);
a clutch assembly (21);
a cylindrical input shaft (13) coupled between the input hub and stator;
a cylindrical damper (15, 73, 71, 15A) press fit around a portion of the input shaft;
a transmission assembly (16) operatively coupled to the clutch assembly; and
lobed rotors (12) operatively coupled to the transmission assembly,
wherein, when stator (19) couples to the clutch assembly (21) and the input shaft (13) rotates, the damper resists the rotation, thereby creating heat.

18. The pump of claim 17, wherein the damper (15A) is cylindrical and tubular.

19. The pump of claim 17, further comprising a visco-elastic material (75) between the input shaft (13) and the damper (15, 15A, 73).

20. The pump of claim 19, further comprising caps (71) surrounding ends of the visco-elastic material (75), the caps toleranced to press the ends of the visco-elastic material against the input shaft (13).

21. The pump of claim 19, wherein the damper (73) comprises a hole (79) for injection molding the visco-elastic material.

22. The pump of claim 19, wherein one or both of the first cap and the second cap comprise a hole (77) for injection molding the visco-elastic material.

23. The pump of claim 18, wherein the damper (15A) comprises a longitudinal slit (15B).

24. The pump of claim 17, wherein:
the cylindrical input shaft comprises a first area (A1) with a first diameter (D1), a second area (A2) with a second diameter (D2), and a third area (A3) with a third diameter (A3), where the second diameter is greater than the first diameter and the second diameter is greater than the third diameter; and
the damper (15) is press fit around the second area (A2).

25. The pump of claim 24, wherein the damper comprises a first cap (71) press fit to a first end of the second area (A2) and a second cap (71) press fit to a second end of the second area (A2), and wherein a bushing (73) is affixed to the first cap and to the second cap.

26. The pump of claim 17, wherein the cylindrical input shaft comprises a first area (A1) with a first diameter (D1), a second area (A2) with a second diameter (D2), a third area (A3) with a third diameter (A3), a fourth area (A4) with a fourth diameter (D4), and a fifth area (A5) with a fifth diameter (D5), wherein the fourth area (A4) is between the first area (A1) and the second area (A2), wherein the fifth area is between the second area (A2) and the third area (A3), wherein the fourth diameter (D4) is equal to the fifth diameter (D5), wherein the fourth diameter (D4) is greater than each of the first diameter (D), the second diameter (D2) and the third diameter (D3), and wherein the damper (15) is press fit to the fourth area (A4) and to the fifth area (A5).

27. The pump of claim 26, further comprising a first bearing surrounding a portion of the first area; a second bearing surrounding a portion of the third area; and the stator press fit to another portion of the third area.

28. The pump of claim 24, further comprising a first bearing surrounding a portion of the first area; a second bearing surrounding a portion of the third area; and the stator press fit to another portion of the third area.
